(19) United States
(12) Patent Application Publication
(10) Pub. No.: US 2007/0181061 A1
(43) Pub. Date: Aug. 9, 2007

(54) Dispensing apparatus

(76) Inventor: Neil Whittle, Cheshire (GB)

Correspondence Address: WINSTEAD SECHREST & MINICK P.C., PO BOX 50784, DALLAS, TX, 75201, US

(21) Appl. No.: 10/561,250

(22) PCT Filed: Jun. 14, 2004
(86) PCT No.: PCT/GB04/02513

§ 371 Date: Apr. 27, 2006

(30) Foreign Application Priority Data
Jun. 13, 2003 (GB) 0313883.1

(51) Int. Cl. B05D 7/22; B05B 13/06

(52) U.S. Cl. 118/317; 427/181

(57) ABSTRACT

Dispensing apparatus is provided for use in dispensing a fluid lining material onto the interior wall surfaces of a conduit. The dispensing apparatus includes at least one reservoir for the containment of at least one fluid, dispensing outlet means communicating with said at least one reservoir for dispensing fluid therefrom and a rotational head member for directing the dispensed fluid from said dispensing outlet means in a required direction onto the walls of the conduit. The rotational head member has an opening which faces the remainder of the apparatus and said head member is capable of undergoing reciprocal motion relative to a further part of the apparatus in use to allow multiple layers of fluid lining to be provided in a single pass of the apparatus through the conduit. A directional member is provided in the recess portion and fluid dispensed from said dispensing outlet means impacts initially with an outer surface of said directional member prior to flowing out of said recess portion.

### CROSS-REFERENCE TO RELATED APPLICATION

This application is a 371 National Phase of PCT/GB2004/002513 filed on 14 Jun. 2004, which claims priority to GB 0313883.1 filed on 16 Jun. 2003.

### TECHNICAL FIELD

This invention relates to fluid dispensing apparatus, and particularly although not necessarily exclusively, to fluid dispensing apparatus for dispensing a fluid lining material onto one or more walls of a conduit, pipe or channel.

### BACKGROUND INFORMATION

Conduits and channels are used in a wide range of industries for transportation of a fluid or solid or storage thereof, such as for example, for use in the transportation of gas, water, sewage and/or the like. Although the following description makes reference to fluid dispensing apparatus for use in dispensing a lining material in generally cylindrical water or gas pipes, it will be appreciated by persons skilled in the art that the present invention has far wider application and can be used in any shaped or dimensioned conduit or channel for use in any industry.

A problem with water pipes is that scale can build up on interior walls thereof, thereby restricting the quantity and flow of water through the pipe. In addition, many water pipes in use today are old and are susceptible to corrosion and leakage. This is particularly problematic with gas or sewage pipes, wherein leakage thereof has both dangerous and environmental implications. In order to overcome this problem, the pipes either have to be replaced regularly or a new smaller pipe inserted in the older pipe. However, this typically requires the digging up of roads or pavements, which is inconvenient and expensive. Alternatively, the pipes can be refurbished by applying a lining material to the interior walls of the pipe to increase the structural properties and strength of the pipe. This lining material can be applied manually by workers entering the conduit and spraying a fluid thereon which cures to form a substantially rigid liner, or can be applied automatically, typically using remote controlled dispensing apparatus.

An example of a conventional remote controlled dispensing apparatus for dispensing a lining fluid onto interior walls of a conduit is disclosed in EP1174191. The dispensing apparatus in this patent application includes reservoirs for the containment of fluid which are connected to two dispensing outlets, each outlet for dispensing a different fluid component therefrom. Drive means are provided for driving the movement of the apparatus through a conduit and a cup shaped rotary head is provided opposite the two dispensing outlets onto which the two fluid components are dispensed for mixing. The cup shaped rotary head spins the mixture out of an open end thereof onto the interior walls of the conduit.

A problem associated with the abovementioned apparatus and other conventional dispensing apparatus is that the thickness of the lining material applied to the conduit walls is often too thin, thereby making the lining brittle and requiring passing of the apparatus through the conduit a number of times in order for the required thickness of lining material to be built up by the application of multiple layers (i.e. “a multiple pass system”). This is both expensive and time consuming. To the best of the applicants knowledge, it is not currently possible to apply a number of layers of lining material on an area of a conduit wall at any one time due to the prolonged period of time it takes for conventional lining fluids to cure. Furthermore, application of a thicker single layer of lining fluid is not possible since the lining material begins to sag and provides an uneven distribution of material on the interior conduit walls.

In an attempt to overcome this problem, dispensing apparatus has been provided where the rotary head is capable of undergoing reciprocal motion relative to the apparatus, thereby allowing a plurality of layers of fluid to be dispensed during linear motion of the apparatus through a conduit, such as the apparatus disclosed in EP145266 and GB2160289.

In EP145266, a plurality of apertures are provided in the side wall of the rotary head through which the fluid passes for spraying onto the walls of the conduit. A problem with this type of head arrangement is that the apertures are likely to become blocked when used with a rapid curing fluid mixture.

In GB2160289, the rotary head includes three cup members along which the fluid travels prior to being dispensed therefrom. The first cup member is in the form of a cylindrical drum having one end closed by a flat disc, the fluid outlet means terminates adjacent the disc. The wall of the drum includes a plurality of apertures and the fluid impacts the disc and is discharged through the apertures. The fluid then flows along the interior side walls of a truncated cone which diverges outwardly away from the fluid outlet means. The third cup member is connected to the open end of the truncated cone. This third cup member opens out in a direction opposite to the second cup member and the fluid flows from the second cup member along the third cup member inner walls to be dispensed from the free end of the third cup member. A problem with this arrangement is that mixing of the fluids is undertaken in the cup members following dispensing from the fluid outlet means which may lead to inadequate mixing. In addition, there are a number of small apertures that the fluid needs to flow through and these apertures are likely to become blocked when a rapid curing fluid is being dispensed.

It is therefore an aim of the present invention to provide dispensing apparatus which overcomes the abovementioned problems and which provides an inexpensive and simpler alternative to conventional dispensing apparatus.

### SUMMARY OF THE INVENTION

According to a first aspect of the present invention there is provided dispensing apparatus for use in dispensing a fluid lining material onto one or more interior wall surfaces of a conduit, said dispensing apparatus including at least one reservoir for the containment of at least one fluid, dispensing outlet means communicating with said at least one reservoir for dispensing fluid therefrom and a rotational head member for directing the dispensed fluid from the dispensing outlet means in a required direction onto the walls of said conduit, said rotational head member including at least one recess or cavity portion therein into which the dispensing outlet means dispenses the fluid and at least one opening communicating with said recess or cavity portion through which the fluid travels to be dispensed from said head member, said opening of said rotational head member facing the dispensing apparatus and said rotational head member capable of undergoing reciprocal motion relative to a further part of the apparatus in use, at least one directional member provided in the at least one recess portion substantially opposite said outlet means, such that fluid being dispensed from said outlet means impacts an outer surface of said directional member in use, characterized in that the at least one directional member is in the form of a truncated cone.

Thus, the at least one opening defined in the rotational head member is opposite to and faces the apparatus, such as the dispensing outlet means, reciprocating means and/or the like. This is in contrast to the prior art devices wherein head members capable of undergoing reciprocation generally face away from the apparatus, and typically in the direction of travel of the apparatus. The arrangement of the head member and directional member located therein, together with the reciprocation of the head member increases the efficiency and speed for which multiple layers of fluid can be dispensed from the apparatus in a “single pass” of the apparatus through the conduit.

The reciprocal motion and thus the application of multiple layers of fluid on the walls of the conduit typically occurs during linear movement of the dispensing apparatus through the conduit. This motion typically takes place during a single pass of the apparatus through the conduit.

The term conduit can include any type or form of channel, pipe, tubing, sleeve and/or the like of any length and/or shape.

Impact of the fluid in the rotating recessed portion, deflects the fluid therefrom and onto the walls of the conduit. The recessed portion typically has a first open end and the open end is opposite the directional member.

Preferably the opening defined in the head member faces away from the direction of travel in the longitudinal direction of the pipe or conduit.

Preferably the reciprocal motion is in a direction longitudinally of the apparatus and further preferably the motion is at least partially in the direction of travel of the apparatus in the conduit.

The reciprocal motion typically takes place during linear movement of the apparatus though the conduit.

Drive means can be provided to drive the linear movement of the apparatus through the conduit. The same or further drive means can be provided to drive the reciprocal motion means and/or the rotational movement of the head member.

Preferably the reciprocal motion means includes any or any combination of one or more hydraulic pistons, pneumatic pistons, telescopic shafts mechanical components, such as a crank shaft and/or the like.

Preferably damping means are provided in the apparatus to reduce vibrations therein.

In a preferred embodiment the reciprocal motion means includes a ball reverser. The advantage of the ball reverser is that there is no requirement for electronic circuitry or control systems, thereby limiting the cost of manufacture of the same and allowing easy maintenance thereof. Furthermore, the ball reverser requires to be driven in one direction only, thereby simplifying the components required.

In one embodiment both the dispensing outlet means and the head member are capable of undergoing reciprocal motion with respect to the remainder of the apparatus. Alternatively, the head member undergoes reciprocal motion relative to the dispensing outlet means.

Preferably the rotational head member is mounted on the apparatus via connection means. The connection means typically includes at least one shaft or arm member. The shaft or arm member can be rotated by drive means provided in the apparatus, thereby resulting in rotation of the rotational head member. The shaft or arm member can also undergo reciprocal motion.

In one embodiment the drive means which drives the rotation of the head member also drives the reciprocating motion of the head member with respect to the apparatus.

Preferably the rotational head member is rotated at approximately 15,000 RPM.

The rotational head member is typically provided at the front of the apparatus in the direction of travel.

At least some of the dispensed fluid impacts initially with the outer walls of the directional member prior to flowing along the interior side walls of the head member and out of the at least one opening of the head member. The directional member has the advantage that it prevents or at least reduces the build up of fluid in the recessed portion in use, directs the flow of fluid along the interior side walls of the head member and aids the even distribution of fluid from the rotational head onto the conduit walls.

In one embodiment the at least one directional member is in the form of a truncated cone. The cone is typically located on the wall of the recessed portion directly opposite the dispensing outlet means, thereby ensuring the dispensed fluid impacts initially with the outer tapered walls of the cone. The base of the truncated cone is typically provided at a point furthest from the dispensing nozzle/outlet means.

The outer side walls of the directional member are planar or straight (i.e. the side walls form a straight line from the top of the directional member to the base of the directional member).

The directional member can be joined to the recessed portion by attachment means or the directional member can be integrally formed with the recessed portion to provide a substantially continuous surface along which the fluid flows from the outer walls of the directional member to the inner side walls of the recessed portion and through an opening in the recessed portion.

The shaft or arm member which results in rotation of the rotation and/or reciprocation of the head member can be located through the truncated portion of the cone and typically substantially centrally thereof.

The side walls of the truncated cone typically diverge outwardly in a direction away from the dispensing outlet means. The side walls of the recess portion diverge outwardly in a direction opposite to the side walls of the truncated cone.

Preferably the outermost interior side walls of the recessed portion are inclined at an acute angle with respect to the longitudinal axis of the head member, thereby aiding the deflection or flow of the fluid from the recessed portion and onto the walls of the conduit.

In one embodiment the dispensing outlet means is in the form of a housing having at least two inlets, an outlet and at least one mixing compartment located between said inlets and outlets. The mixing compartment acts as an impingement mixing chamber allowing at least two different fluids to be separately delivered to the compartment via the two inlets prior to being mixed and dispensed from said outlet. The mixing typically takes place under high pressure. The ability to mix the fluids in the compartment just prior to dispensing from said outlet is advantageous, particularly if the fluids, when mixed, have a rapid curing or reaction time.

Preferably the fluid dispensed from the apparatus has a curing time which is only slightly greater than the time taken for the component fluids to be mixed, dispensed onto the head member and deflected therefrom, but which is less than the time taken for the head member to complete a single reciprocating motion. This allows a first fluid lining to be located on the conduit and cured prior to a second fluid lining to be located thereon.

For example, in a preferred embodiment of the present invention the fluid being dispensed includes an amine and an aromatic isocyanate which, on mixing results in a mixture having a curing time of less than 60 seconds. Thus, it is essential that the mixing compartment is adjacent the dispensing outlet to prevent curing of the mixture and thus blockage of the outlet.

Preferably the fluid being dispensed from the apparatus has a curing time of less than 10 seconds. Further preferably the fluid has a curing time of approximately 3 seconds.

Preferably the dimensions of the mixing compartment and/or outlet are less than the dimensions of the two inlets, thereby ensuring increased pressure in the compartment relative to the inlet passages to allow rapid flow of mixed fluid therethrough. This prevents or at least reduces curing of the mixed fluid in the compartment.

Preferably the dispensing outlet means is a spaced distance apart from said head member such that the fluid has to move through free space prior to impacting with a portion of the directional means.

Control means are typically provided with the dispensing apparatus, either directly thereon or remotely therefrom, for controlling any or any combination of the rotational speed of the head member, the reciprocating speed of the head member, the temperature of the one or more fluids and/or the pressure of fluid delivery of the one or more of fluids in the apparatus.

According to separate and independently claimable aspects of the present invention there is provided a head member and dispensing outlet means.

According to a yet further aspect of the present invention there is provided a method of applying a fluid onto a surface of a conduit using dispensing apparatus, said method including the steps of mixing two or more component fluids in dispensing outlet means, dispensing said mixed fluids in at least one recess portion of a rotational head member and deflecting said mixed fluids through at least one opening defined in said rotational head member onto the conduit surface, said at least one opening communicating with said recess portion, the opening of said rotational head member facing the dispensing apparatus and the rotational head member caused to undergo reciprocal motion relative to a further part of the apparatus in use, at least one directional member is provided in the at least one recess portion substantially opposite said outlet means, such that fluid being dispensed from said outlet means impacts an outer surface of said directional member in use, characterized in that the at least one directional member is in the form of a truncated cone.

According to yet further aspects of the present invention there is provided use of a lining fluid with dispensing apparatus and lining fluid dispensing apparatus.

The advantage of the present invention is that the fluid dispensing apparatus allows a multilayered lining to be applied to the interior walls of conduits in a single pass of the apparatus through the conduit. This allows any required thickness of lining to be produced. The lining fluid rapidly cures on application to the walls of the conduits, thereby protecting the conduit from deterioration/corrosion and increasing the structural properties thereof. The lining fluid applied in accordance with the present invention provides a smooth, even and glossy finish to the interior wall surfaces of the conduit, thereby reducing the build up of scale or other debris/contaminants thereon.

The fluid dispensing apparatus can be used for the refurbishment of existing conduits or channels and/or can be used to provide a lining on new conduits or channels.

### BRIEF DESCRIPTION OF THE DRAWINGS

The foregoing summary as well as the following detailed description of the preferred embodiment of the invention will be better understood when read in conjunction with the appended drawings. It should be understood, however, that the invention is not limited to the precise arrangements and instrumentalities shown herein. The components in the drawings are not necessarily to scale, emphasis instead being placed upon clearly illustrating the principles of the present invention. Moreover, in the drawings, like reference numerals designate corresponding parts throughout the several views.

The invention may take physical form in certain parts and arrangement of parts. It will also be understood that certain of the above-described structures, functions and operations of the above-described embodiments are not necessary to practice the present invention and are included in the description simply for completeness of an example embodiment or embodiments. In addition, it will be understood that specific structures, functions and operations set forth in the patents and publications referenced herein can be practiced in conjunction with the present invention, but they are not essential to its practice. It is therefore to be understood that within the scope of the claims, the invention may be practiced otherwise than as specifically described without actually departing from the spirit and scope of the present invention. Finally, all patents, publications and standards referenced herein are hereby incorporated by reference.

For a more complete understanding of the present invention, and the advantages thereof, reference is now made to the following descriptions taken in conjunction with the accompanying drawings, in which:

FIG. 1 is a cross sectional view of dispensing apparatus according to an embodiment of the present invention;

FIGS. 2a and 2b illustrate the dispensing apparatus in two positions during reciprocal motion;

FIG. 3 is a cross sectional view of directional means according to one embodiment of the present invention;

FIGS. 4a and 4b illustrate a cross sectional view and an end view respectively of dispensing outlet means in one embodiment;

FIGS. 5a-5d illustrate dispensing apparatus according to the present invention in use in conduits; and

FIGS. 6a and 6b illustrate a cross sectional view and an end view respectively of dispensing outlet means according to a further embodiment of the present invention.

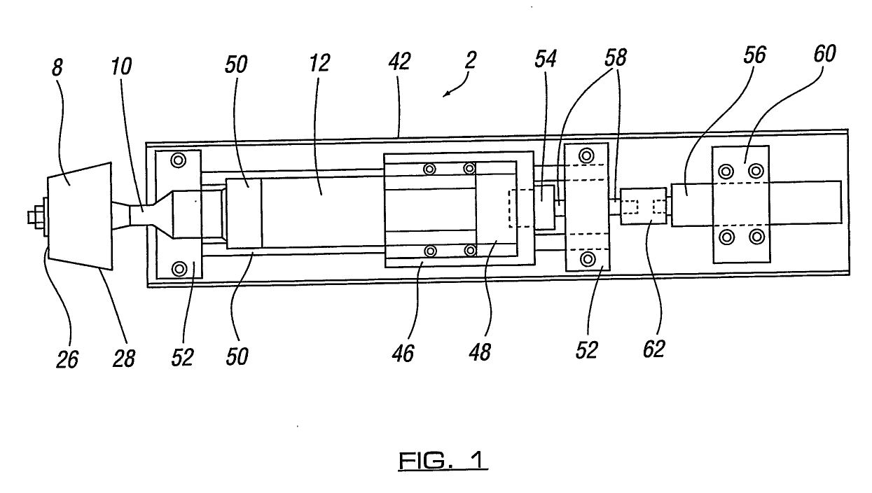

### DETAILED DESCRIPTION OF THE INVENTION

Referring to the figures, there is illustrated dispensing apparatus 2 for the dispensing of a fluid lining mixture for lining the interior walls of a conduit 4.

The fluid lining mixture for use with the apparatus of the present invention in one example, when cured, provides a lining which is sufficiently strong and resistance to wear and corrosion and which is capable of standing alone (i.e. forms a conduit within a conduit), even after the original outer conduit has eroded away.

The mixture includes an amine and an aromatic isocyanate, together with a filler component which typically has a cleaning function in the apparatus of the present invention, and an optional coloring pigment, which can be used to identify the function of the pipe, such as gas or water pipe. Conventionally, filler components have been used in lining mixtures but only to provide bulk thereto and not to provide a cleaning function as in the present invention.

The fluid lining, when mixed, cures rapidly and typically within approximately 3 seconds, especially formulated to avoid the problem of shrinking associated with conventional lining mixtures. Due to the rapid curing of the mixture, this allows multiple layers of lining material to be applied to the interior walls of a conduit in rapid succession, thereby allowing the thickness of the lining to be built up quickly, typically up to thicknesses of 6-8 mm, or possibly greater in some cases. However, the rapid curing rate creates the potential problem of curing of the fluid in the apparatus prior to application on the conduit walls. Thus, the present invention has been designed to utilize the advantages provided by the rapid curing liner mixture whilst overcoming conventional problems associated therewith.

In accordance with the present invention, the dispensing apparatus 2, includes dispensing outlet means in the form of a spray nozzle 6 for dispensing fluid pumped from a reservoir (not shown) therefrom, a rotational head 8 for directing the dispensed fluid onto the conduit walls 4 and drive means (not shown) for driving the movement of apparatus 2 through the conduit.

The rotational head 8 is connected to apparatus 2 via a drive shaft 10. Rotation of drive shaft 10 and thus rotation of the rotational head 8 is driven by a pneumatic air motor 12.

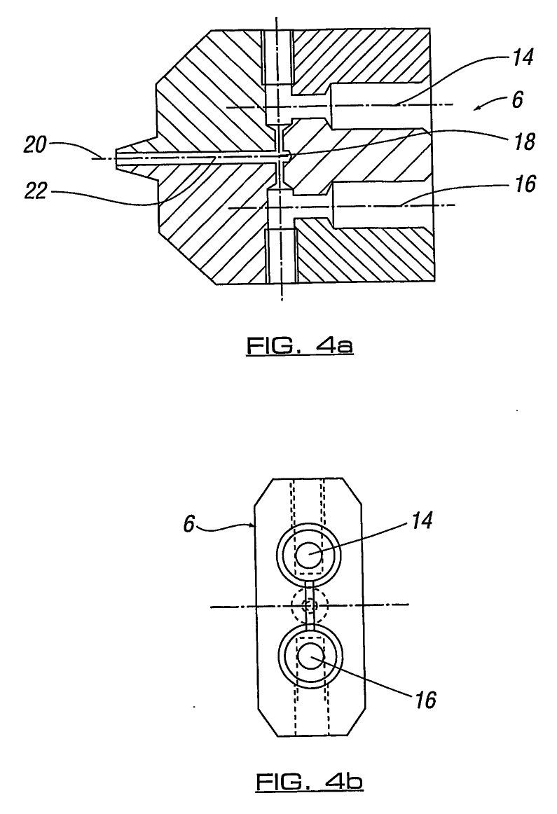

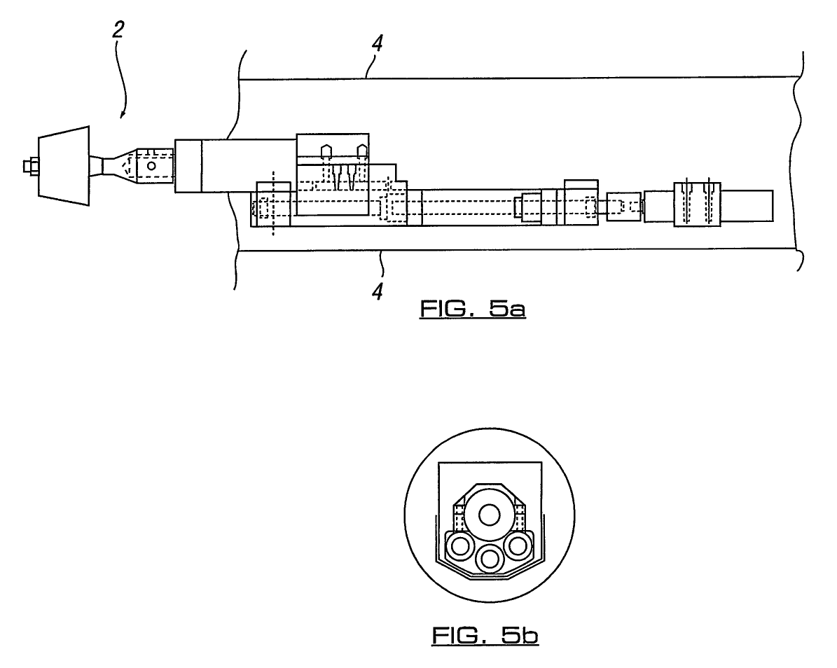

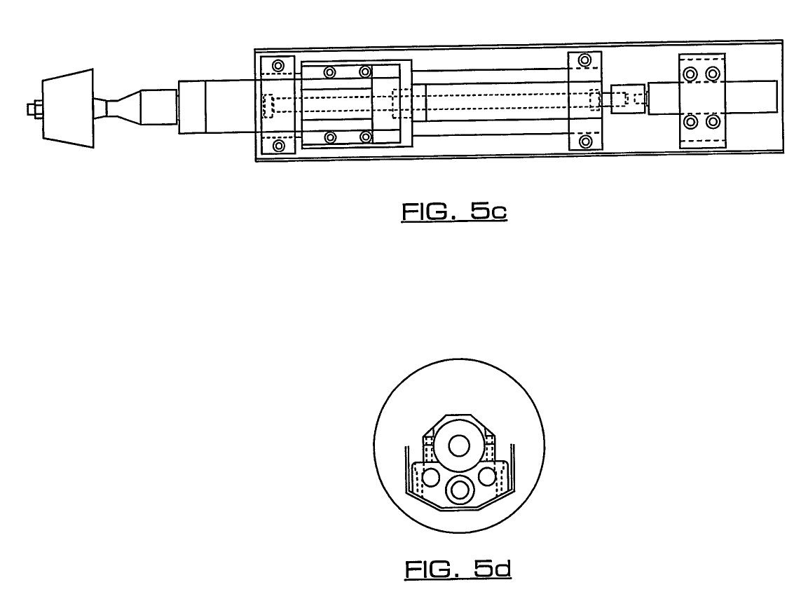

Each component of the two component lining fluid (amine and aromatic isocyanate) is separately pumped into the spray nozzle 6 via inlet channels 14, 16, as shown in FIGS. 4a and 4b. The inlet channels 14, 16 are connected to pipes through which the fluid components are pumped from reservoirs typically located remotely from the applicator part of the dispensing apparatus. The fluids then enter and become mixed in a compartment 18 prior to being dispensed through open end 20 of outlet passage 22.

The diameter of compartment 18 is less than the diameter of inlet channels 14, 16, thereby ensuring rapid flow of the mixture through compartment 18 to prevent curing of the mixture therein.

The open end 20 of spray nozzle 6 oppositely faces rotational head 8, thereby allowing fluid dispensed from open end 20 to impact a surface of head 8 in a recessed portion 24 thereof. The rotational head 8 is generally cup shaped including a closed end 26, side walls 28 and an open end 30. At least the interior surface of side walls 28, which define the recessed portion 24, together with end 26, taper outwardly relative to a longitudinal axis of the head indicated by reference 32. The closed end of the head is typically located at the front of the apparatus and faces the direction of travel of the apparatus in use.

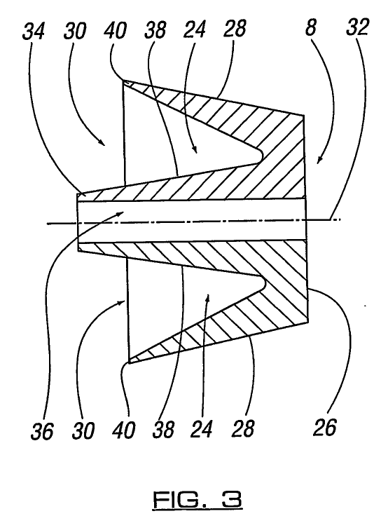

A truncated cone 34 is provided substantially centrally of the recessed portion 24 of the rotational head, as shown in FIG. 3. A channel 36 is provided through the truncated cone for location of drive shaft 10 therein. The side walls 38 of truncated cone 34 diverge outwardly in an opposite direction to the outermost interior side walls of head 8 (i.e. towards end 26) and are at an angle of less than 90 degrees to the longitudinal axis 32. The angle of the interior side walls 28 relative to the longitudinal axis is greater than 0 degrees and less than 90 degrees. For example, the angle can be any of 45, 50, 55, 60, or 65 degrees.

During dispensing, a bead of fluid is directed onto side wall 38 of truncated cone 34, which directs the flow of the fluid in the direction of dispensing/impact, thereby preventing fluid flow back towards the dispensing nozzle which would typically result in a build up of cured material on the head. As such, the fluid flows towards closed end 26 via side walls 38 and then towards open end 30 via outermost interior side walls 28 as a result of rotation of head 8. When the fluid reaches outermost edge 40 of the head it is spun outwardly onto the walls of the conduit. This process occurs rapidly due at least in part to the rapid rotation of the head, thereby preventing or at least reducing the likelihood of fluid curing on the head.

The width of the side walls of the head member is greater adjacent the closed end (26) compared to the free edge (40) adjacent the open end (30).

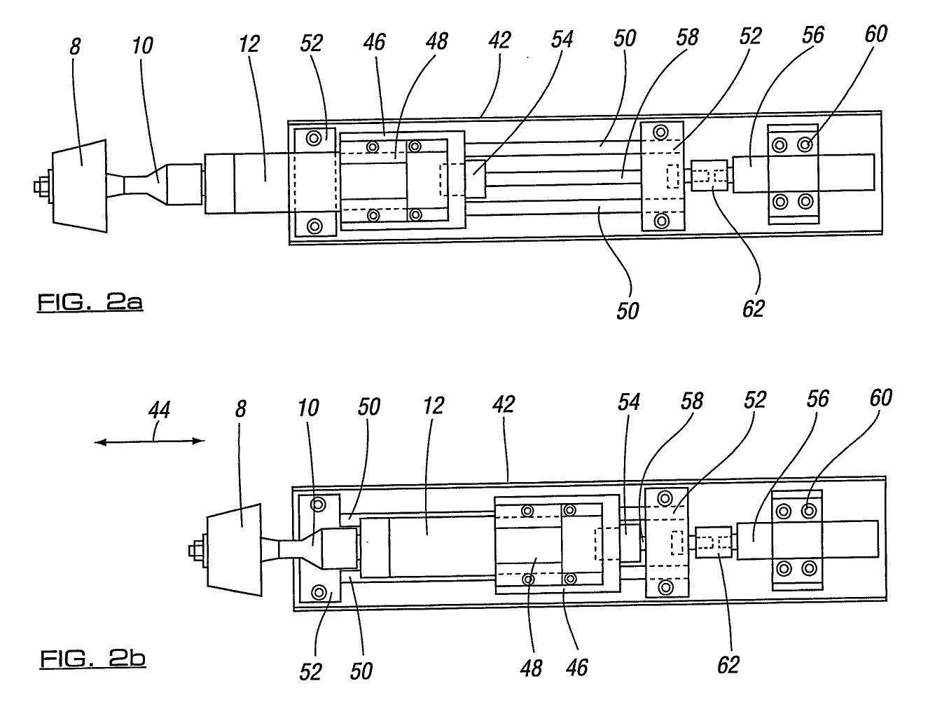

In accordance with a further aspect of the present invention, in order to allow multiple layers of lining fluid to be applied in rapid succession, reciprocating means are provided to allow the head 8 and dispensing nozzle 6 to undergo reciprocal motion relative to the housing 42 of the apparatus and conduit. This reciprocal motion is typically substantially simultaneous to linear movement of the apparatus along the conduit. FIG. 2a illustrates head 8 in an extended position relative to housing and FIG. 2b illustrates head 8 in a retracted position. Arrow 44 illustrates movement of head 8 in a forwards and backwards direction between said extended and retracted positions. The provision of reciprocal means allows multiple layers of lining material to be provided to reach a required thickness during only a single pass of the apparatus through the conduit.

The reciprocal means drives movement of carriage 46, which includes ceramic linear bearings and which is connected to motor 12 via motor clamp 48. The motor 12 in turn is connected to the rotational head and dispensing nozzle. Carriage 46 moves backwards and forwards along linear shafts 50 provided between end plates 52 in housing 42.

The reciprocal means includes a ball reverser comprising a ball reverser nut 54 which is driven by motor 56 in a forwards and backwards direction along a ball reversing screw 58 (cross hatch arrangement not shown for purposes of clarity). Motor 56 is typically a reverser driven air motor which drives nut 54, and thus carriage 46 in a single direction only, the arrangement of channels/grooves on screw 58 allowing movement of the nut in a forwards and backwards direction. A clamp 60 is provided for clamping motor 56 in position within housing 42 and a flexible coupling 62 is provided between reverser screw 58 and motor 56.

Other components can be provided in the apparatus, such as heating means (i.e. heat exchanger) for heating the lining components to keep them fluid in the apparatus (i.e., up to 75° C.), micro-processing means or metering system for controlling the temperature, speed and/or pressure of the fluid in the apparatus, purge means (i.e. nitrogen purge system) for purging the isocyanate component, fluid reservoirs, pumps, filter means, control means for controlling the speed of linear movement of the apparatus through the conduit (i.e. hose or winch speed) and/or any of the abovementioned components.

The reciprocating distance between the extended and retracted positions of head 8 typically depends on the curing time of the lining mixture used, the size of the equipment, the size of the conduit and/or the like. The minimum distance of reciprocation is typically 100 min since sufficient time must pass between repeated motions to allow curing of the lining material previously applied.

The conduit can be any size or shape, such as for example square, rectangular or circular in cross section.

In the above described embodiment the motor 12, motor clamps 48, shaft 10, head 8, dispensing nozzle 6 all can be provided to undergo reciprocal motion during use of the apparatus.

However, it will be appreciated that any combination of the above could be provided to undergo reciprocal motion. In a preferred embodiment, the head 8 and nozzle 6 undergo reciprocal motion only, thereby reducing the wear and tear on the other components as a result of movement. Since the weight of moving components is reduced, this also reduces the inertia/momentum of the apparatus in use, thereby making it easier and quicker for the apparatus to be made stationary and/or moved in a reverse direction. This also removes the requirement for flexing of the fluid hoses delivering fluid to the apparatus.

The motor/drive means used for driving the reciprocating motion of one or more parts of the apparatus can also be used to drive rotation of said head. Alternatively, a separate motor/drive means can be provided.

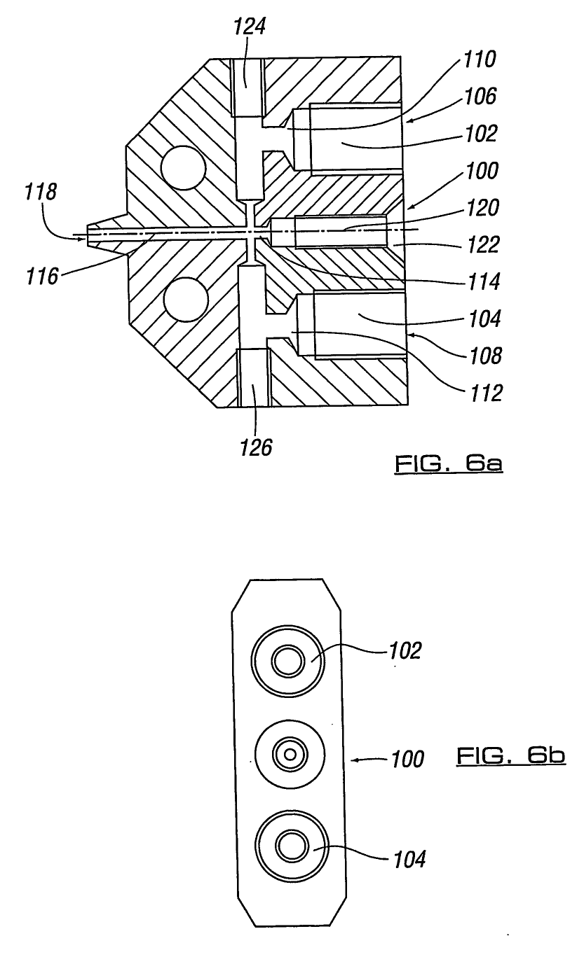

In the embodiment shown in FIGS. 6a and 6b, dispensing outlet means are provided in the form of spray nozzle 100. The nozzle 100 has inlet channels 102, 104 with openings 106, 108 respectively which communicate with fluid reservoirs and openings 110, 112 respectively communicating with a mixing compartment 114. An outlet channel 116 communicates with the mixing compartment 114 at a first end and has an outlet aperture 118 at an opposite end. In addition, a further channel 120 is provided in nozzle 100 which has an end in communication with mixing compartment 114 and a second open end 122 in which closure means in the form of a locking screw is provided. This screw can be removed and a drill can be inserted therethrough to allow drilling and thus release of any fluid which has built up and/or cured in the mixing chamber 114. Side apertures 124, 126 can also be provided in the housing to allow drill bits to be located therein to aid cleaning of the nozzle. This is required since solvent which may be used for cleaning in some applications of the nozzle may not be used when the nozzle is used in drinking water applications and where the presence of any solvent is not allowed.

Thus, the present invention provides dispensing apparatus, typically remote controlled, and method of use thereof, which allows any required thickness of lining to be applied to a surrounding following a single pass. The number of reciprocal motions undertaken by at least part of the apparatus typically depends on the thickness of the lining material required.

In one embodiment the directional member extends beyond the opening of the recessed portion of the head member. In an alternative embodiment the directional member is recessed within said recessed portion of the head member.

1. A dispensing apparatus for use in dispensing a fluid lining material onto one or more interior wall surfaces of a conduit, said dispensing apparatus comprising:
at least one reservoir for the containment of at least one fluid;
a dispensing outlet means communicating with said at least one reservoir for dispensing fluid therefrom;
a rotational head member for directing the dispensed fluid from the dispensing outlet means substantially towards the walls of said conduit; and
a reciprocating member, operatively coupled to said rotational head member, for reciprocating said rotational head member;
wherein said rotational head member comprises:
at least one recess into which the dispensing outlet means substantially dispenses the fluid;
at least one opening communicating with said recess through which the fluid travels to be dispensed from said head member; wherein said opening of said rotational head member substantially faces the dispensing apparatus; and and
at least one directional member provided substantially in said at least one recess, substantially opposite said outlet means, such that fluid being dispensed from said outlet means impacts an outer surface of said directional member in use; and wherein the at least one directional member comprises a truncated cone.

2. The dispensing apparatus according to claim 1 wherein at least one arm member operatively couples the rotational head member to the dispensing apparatus.

3. The dispensing apparatus according to claim 2 wherein the arm member is operatively coupled to the truncated portion of the cone.

4. The dispensing apparatus according to claim 1 wherein the side walls of the directional member diverge outwardly in a direction away from the dispensing outlet means.

5. The dispensing apparatus according to claim 1 wherein the side walls of the recess portion diverge outwardly in a direction opposite to the side walls of the directional member.

6. The dispensing apparatus according to claim 1 wherein the outer side walls of the directional member are substantially straight.

7. The dispensing apparatus according to claim 1 wherein said at least one fluid and a second fluid are mixed substantially within the dispensing outlet means prior to being dispensed onto said directional member.

8. The dispensing apparatus according to claim 1 wherein the directional member is substantially integrally formed with said head member to provide a substantially continuous surface along which the fluid flows from the outer side walls of the directional member to the inner side walls of the recessed portion.

9. The dispensing apparatus according to claim 1 wherein the rotational head member comprises a cup with side walls, a first closed end and a second open end, the at least one recess portion being substantially defined between the side walls, the first closed end and the second open end.

10. The dispensing apparatus according to claim 9 wherein the width of the side walls of the head member adjacent to said first closed end is greater than the width of the side walls of the head member adjacent the second open end.

11. The dispensing apparatus according to claim 1 wherein the fluid is dispensed from the apparatus during a single pass of the apparatus through the conduit.

12. The dispensing apparatus according to claim 1 wherein the reciprocal motion substantially parallel to a path traveled by the apparatus.

13. The dispensing apparatus according to claim 1 wherein the apparatus is manually pulled through a conduit in use.

14. The dispensing apparatus according to claim 1 further comprising a drive means provided to drive movement of the apparatus through a conduit in use.

15. The dispensing apparatus according to claim 1 wherein said reciprocating member comprises a component chosen from the group consisting of: one or more hydraulic pistons, pneumatic pistons, ball reverser and mechanical components such as a crank shaft.

16. The dispensing apparatus according to claim 1 wherein the dispensing outlet means comprises a housing having at least two inlets, an outlet and at least one mixing compartment located substantially between said inlets and outlet.

17. The dispensing apparatus according to claim 16 wherein the diameter of the mixing compartment is less than the diameter of each of the at least two inlets.

18. The dispensing apparatus according to claim 1 wherein the dispensing outlet means comprises at least one channel provided with a closure means operatively coupled to an open end of said one chanel.

19. The dispensing apparatus according to any preceding claim 1 wherein the fluid dispensed from said apparatus has a curing time which is only slightly greater than the time taken for the component fluids to be mixed, dispensed onto the rotational head member and deflected therefrom but is less than the time taken for the rotational head member to complete a single reciprocating movement.

20. The dispensing apparatus according to claim 1 wherein the fluid being dispensed comprises an amine and an aromatic isocyanate.

21. The dispensing apparatus according to claim 1 wherein the fluid being dispensed from the apparatus has a curing time of substantially less than 10 seconds.

22. The dispensing apparatus according to claim 1 wherein the fluid being dispensed from the apparatus has a curing time of approximately 3 seconds.

23. The dispensing apparatus according to claim 1 further comprising control means operatively coupled to the apparatus to control an element selected from the group consisting of: rotational speed of the rotational head member, reciprocating speed of the rotational head member, the temperature of the one or more fluids, and the pressure of the fluid delivery of the one or more fluids in the apparatus.

24. The dispensing apparatus according to claim 1 wherein the dispensing outlet means is a spaced distance apart from the rotational head member such that dispensed fluid moves through free space prior to impacting a portion of the head member.

25. The dispensing apparatus according to claim 1 further comprising a drive means, operatively coupled to the rotational head member, to drive rotation of the head member.

26. The dispensing apparatus according to claim 25 wherein the drive means for rotating the head member also drives the reciprocating member.

27. The dispensing apparatus according to claim 25 further comprises a second drive means, operatively coupled to the reciprocating member, for driving the reciprocating member.

28. The dispensing apparatus according to claim 1 wherein the rotational head member is rotated at approximately 15,000 RPM.

29. The dispensing apparatus according to claim 1 wherein the directional member extends beyond the opening of the head member.

30. A rotational head member for use with a fluid dispensing apparatus that dispenses a fluid lining material onto one or more interior wall surfaces of a conduit;
wherein said dispensing apparatus comprises a dispensing outlet means, communicating with at least one reservoir, for dispensing fluid therefrom;
wherein said rotational head member, operatively coupled to said dispensing apparatus, directs the dispensed fluid from the dispensing outlet means substantially towards the walls of said conduit;
wherein said rotational head member comprises:
at least one recess into which the dispensing outlet means substantially dispenses the fluid;
at least one opening communicating with said recess through which the fluid travels to be dispensed from said head member; wherein said opening of said rotational head member substantially faces the dispensing apparatus; and
at least one directional member provided substantially in said at least one recess, substantially opposite said outlet means, such that fluid being dispensed from said outlet means impacts an outer surface of said directional member in use; and the at least one directional member comprises a truncated cone; and
further wherein said dispensing apparatus further comprises a reciprocating member, operatively coupled to said rotational head member, for reciprocating said rotational head member.

31. A dispensing outlet means for use with a fluid dispensing apparatus that dispenses a fluid lining material onto one or more interior wall surfaces of a conduit,
wherein said dispensing apparatus comprises at least one reservoir for the containment of at least one fluid;
wherein said dispensing outlet means is operatively coupled with said at least one reservoir for dispensing fluid therefrom; and
further wherein a rotational head member, operatively coupled to said dispensing apparatus, directs the dispensed fluid from the dispensing outlet means substantially towards the walls of said conduit;
further wherein said rotational head member comprises:
at least one recess into which the dispensing outlet means substantially dispenses the fluid;
at least one opening communicating with said recess through which the fluid travels to be dispensed from said head member; wherein said opening of said rotational head member substantially faces the dispensing apparatus; and
at least one directional member provided substantially in said at least one recess, substantially opposite said outlet means, such that fluid being dispensed from said outlet means impacts an outer surface of said directional member in use; and the at least one directional member comprises a truncated cone; and
further wherein said dispensing apparatus further comprises a reciprocating member, operatively coupled to said rotational head member, for reciprocating said rotational head member.

32. A method of applying a fluid onto a surface of a conduit using a dispensing apparatus, said method comprising the steps of:
mixing two or more component fluids substantially in a dispensing outlet means;
dispensing said mixed fluids substantially in at least one recess portion of a rotational head member;
deflecting said mixed fluids substantially through at least one opening defined substantially in said rotational head member, onto the conduit surface, said at least one opening communicating with said recess portion; wherein the opening of said rotational head member substantially faces the dispensing apparatus; and
reciprocating the rotational head member;
wherein at least one directional member is provided substantially in the at least one recess portion substantially opposite said outlet means, such that fluid being dispensed from said outlet means impacts an outer surface of said directional member in use;
wherein the at least one directional member comprises a truncated cone.

33. The dispensing apparatus according to claim 1 wherein the apparatus is pulled through a conduit in use via manually activated means.

34. The dispensing apparatus according to claim 16 wherein the diameter of the outlet is less than the diameter of each of the at least two inlets.

35. The rotational head member according to claim 30 wherein the side walls of the recess portion diverge outwardly in a direction opposite to the side walls of the directional member.

36. The rotational head member according to claim 30 wherein the directional member is substantially integrally formed with said head member to provide a substantially continuous surface along which the fluid flows from the outer side walls of the directional member to the inner side walls of the recessed portion.

37. The rotational head member according to claim 30 wherein the rotational head member comprises a cup with side walls, a first closed end and a second open end, the at least one recess portion being substantially defined between the side walls, the first closed end and the second open end.

38. The rotational head member according to claim 30 wherein the width of the side walls of the head member adjacent to said first closed end is greater than the width of the side walls of the head member adjacent the second open end.

39. The dispensing outlet means according to claim 31 wherein said at least one fluid and a second fluid are mixed substantially within the dispensing outlet means prior to being dispensed onto said directional member.

40. The dispensing outlet means according to claim 31 comprises a housing having at least two inlets, an outlet and at least one mixing compartment located substantially between said inlets and outlet.

41. The dispensing outlet means according to claim 40 wherein the diameter of the mixing compartment is less than the diameter of each of the at least two inlets.

42. The dispensing outlet means according to claim 40 wherein the diameter of the outlet is less than the diameter of each of the at least two inlets.

43. The dispensing outlet means according to claim 31 wherein the dispensing outlet means comprises at least one channel provided with a closure means operatively coupled to an open end thereof.

44. The dispensing outlet means according to claim 31 wherein the dispensing outlet means is a spaced distance apart from the rotational head member such that dispensed fluid moves through free space prior to impacting a portion of the head member.
